(19) United States
(12) Patent Application Publication
(10) Pub. No.: US 2009/0240356 A1
(43) Pub. Date: Sep. 24, 2009

(54) Audio Signal Reproduction Apparatus

(75) Inventors: Katsuhiko Goda, Saitama (JP); Yoshiyuki Kakuta, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 11/887,322

(22) PCT Filed: Mar. 28, 2006
(86) PCT No.: PCT/JP2006/306343

§ 371 Date: Nov. 15, 2007

(30) Foreign Application Priority Data
Mar. 28, 2005 (JP) 2005-091916

(51) Int. Cl. G06F 17/00

(52) U.S. Cl. 700/94

(57) ABSTRACT

An audio signal reproduction apparatus reproduces an audio signal from a recording medium for recording an audio signal such as a CD. In the normal reproduction, on receiving a movement instruction (e.g., forward or backward jump instruction of music during reproduction) of a reproduction position of an input audio signal in accordance with operation input of an operator, the audio signal reproduction apparatus calculates the movement amount of the reproduction position, and moves the reproduction position to a position moved with respect to the present reproduction position by the movement amount to execute the reproduction. The movement position of the reproduction position is set by a beat unit of the audio signal forming the music during the reproduction.

### TECHNICAL FIELD

The present invention relates to a movement method of a reproduction position in an audio signal reproduction apparatus.

### BACKGROUND TECHNIQUE

In a dance place and facilities such as a disco and a club, the so-called disc jockey (DJ) reproduces dance music with using a reproduction apparatus of a recording medium such as a CD and an MD. An audio signal reproduction apparatus used by the disc jockey is also referred to as DJ equipment, and examples thereof are disclosed in Patent-References 1 and 2.

Patent Reference-1: Japanese Patent Application Laid-open under No. 2002-341888

Patent Reference-2: Japanese Patent Application Laid-open under No. 2002-352569

The disc jockey sometimes changes a reproduction position of music during reproduction, as need arises. Concretely, the disc jockey operates a fast-forward button and a fast-backward button of the DJ equipment, and moves the reproduction position of the music during the reproduction by a predetermined amount. In the normal method, the movement amount is set to a fixed amount. When a movement instruction of the reproduction position is inputted, certain DJ equipment moves the reproduction position on a disc by a predetermined number of tracks on the recording medium such as an optical disc, and continues the reproduction at the position after the movement. In addition, some DJ equipments set the unit of the movement amount to a predetermined time without prescribing the number of tracks on the disc as a reference.

However, the above movement amount such as a predetermined number of tracks or a predetermined time has no correlation with musical characteristics such as beat and rhythm of the reproduced music. Therefore, it is problematic that, when the reproduction position is moved, continuity of the beat and bar of the reproduced music is not maintained before and after the movement and the rhythm of the music becomes discontinuous.

### DISCLOSURE OF INVENTION

### Problem to be Solved by the Invention

The present invention has been achieved in order to solve the above problem. It is an object of this invention to provide an audio signal reproduction apparatus capable of maintaining a rhythm of music during reproduction and changing a reproduction position without uncomfortable feeling.

### Means for Solving the Problem

According to one aspect of the present invention, there is provided an audio signal reproduction apparatus, including: an input unit which receives a movement instruction of a reproduction position of an input audio signal by a unit of a beat of the audio signal; a movement amount calculation unit which calculates a movement amount of the reproduction position based on the movement instruction; and a reproduction position movement unit which moves the reproduction position with respect to a present reproduction position by the movement amount, wherein the movement amount calculation unit calculates the movement amount by the unit of the beat of the audio signal, based on the movement instruction.

The above audio signal reproduction apparatus reproduces the audio signal from the recording medium for recording the audio signal such as a CD. In the normal reproduction state, on receiving the movement instruction of the reproduction position of the input audio signal by operation input of the operator, e.g., a forward or backward jump instruction of the music during the reproduction, the audio signal reproduction apparatus calculates the movement amount of the reproduction position, and moves the reproduction position to a position moved with respect to the present reproduction position by the movement amount to execute the reproduction. The input unit sets the movement instruction of the reproduction position by the unit of the beat of the audio signal forming the music during the reproduction. Based on the instruction, the movement amount is calculated by the unit of the beat. Thus, since the relation between the reproduction position and the beat position of the music is maintained before and after the movement of the reproduction position, the rhythm of the reproduced music never becomes discontinuous, and the movement of the reproduction position without the uncomfortable feeling becomes possible. Particularly, when the audio signal reproduction apparatus is applied to DJ equipment, the rhythm never becomes discontinuous before and after the movement of the reproduction position such as jump reproduction, and the reproduction of the music suited to a dance can be continued.

In a manner, the above audio signal reproduction apparatus may further include: a detection unit which detects a number of beats per unit time of the input audio signal; and a unit which calculates a time of one beat of the input audio signal based on the number of beats per unit time, wherein the movement amount calculation unit sets the movement amount to an integral multiple of the time of the one beat of the input audio signal.

By detecting the peak level of the audio signal, the number of beats per unit time such as BPM (Beat Per Minute) can be calculated. In addition, the time of the one beat can be calculated from the number of beats per unit time. Therefore, by prescribing the movement amount as the integral multiple of the time of the one beat, the relation between the reproduction position and the beat position never changes before and after the movement, and the reproduction position can be moved with maintaining the beat.

In a preferred example, the movement instruction may include a movement beat number for moving the reproduction position, and the movement amount calculation unit may prescribe a product of the time of the one beat of the input audio signal and the movement beat number as the movement amount. In this example, the movement amount can be easily calculated by the product of the movement beat number inputted by the operator and the time of the one beat.

In another preferred example, the movement instruction may include a movement direction of moving of the reproduction position, and the reproduction position movement unit may move the reproduction position in the movement direction. Thereby, the operator can move the reproduction position in a desired direction and to a desired position in the music.

### BRIEF DESCRIPTION OF THE DRAWINGS

FIG. 1 is a plan view showing an appearance of an operation panel of a CD player according to an embodiment;

FIGS. 2A and 2B are explanation views of a movement method of a reproduction position according to the present invention;

FIG. 3 is another explanation view of the movement method of the reproduction position according to the present invention;

FIG. 4 is a block diagram showing an inside configuration of the CD player according to this embodiment; and

FIG. 5 is a flow chart of a reproduction process including a movement process of the reproduction position.

### BRIEF DESCRIPTION OF THE REFERENCE NUMBER

1 Disc
2 Display unit
3 Turntable
6 Operation unit
21 BPM detection unit
22 Buffer memory
23 Address controller
30 System controller

### DETAILED DESCRIPTION OF THE PREFERRED EMBODIMENTS

The preferred embodiment of the present invention will now be described below with reference to the attached drawings.

### [Appearance of CD Player]

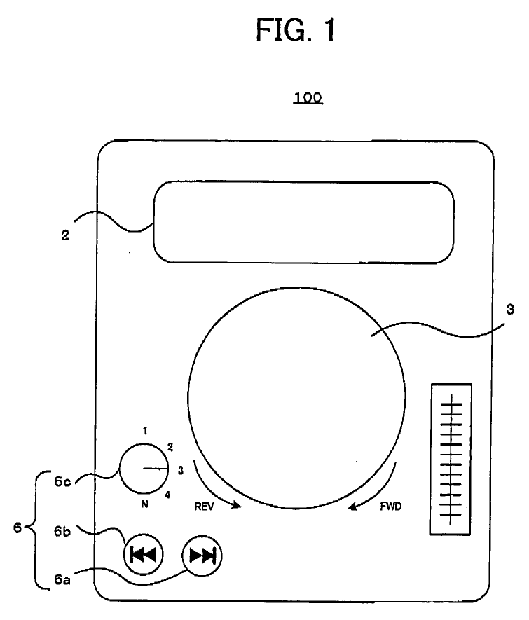

FIG. 1 shows a plan view of an operation panel of a CD player being an embodiment of an audio signal reproduction apparatus of the present invention. A CD player 100 houses a CD inside, and reproduces music in accordance with the operation of an operator such as a disc jockey. A display unit 2, a turntable 3 and a reproduction position movement operation unit 6 (hereinafter, simply referred to as “operation unit 6”) are provided on the operation panel of the CD player 100. The CD player usually used by the disc jockey has various kinds of functions, and plural operation buttons for the functions are provided. However, only the buttons associated with the present invention are shown in FIG. 1.

The display unit 2 is formed by a liquid crystal panel, and displays information such as the number of tracks of the music during reproduction and a reproduction time. The turntable 3 is manually operated by the operator, and has a function to move the reproduction position of the music. In FIG. 1, when the operator rotates the turntable 3 in a clockwise direction, the reproduction position of the music is fast-forwarded. Meanwhile, when the operator rotates the turntable 3 in an anticlockwise direction, the reproduction position of the music is returned.

The operation unit 6 is operated in a case of jumping of the reproduction position, and includes a forward jump button 6a, a backward jump button 6b and a jump beat number button 6c. When the operator operates the forward jump button 6a, the reproduction position of the music moves forward by a predetermined amount. Meanwhile, when the operator operates the backward jump button 6b, the reproduction position of the music moves backward by a predetermined amount. The jump beat number button 6c determines the movement amount of the reproduction position by the jump, and the reproduction position moves by the movement amount corresponding to a product of the amount indicated by the jump beat number button and the beat number of the music during the reproduction. For example, in such a case that the jump beat number button 6c indicates the jump beat number “3” as shown in FIG. 1 and the operator pushes the forward jump button 6a, the reproduction position of the music moves forward with respect to the present reproduction position by the amount of 3 beats.

### [Movement Method of Reproduction Position]

Next, a description will be given of a movement method of the reproduction position according to this embodiment. The present invention is characterized in that the movement amount is determined by the value indicating the musical characteristics of the music during the reproduction, i.e., by the unit of beat, at the time of moving the reproduction position by the jump instruction.

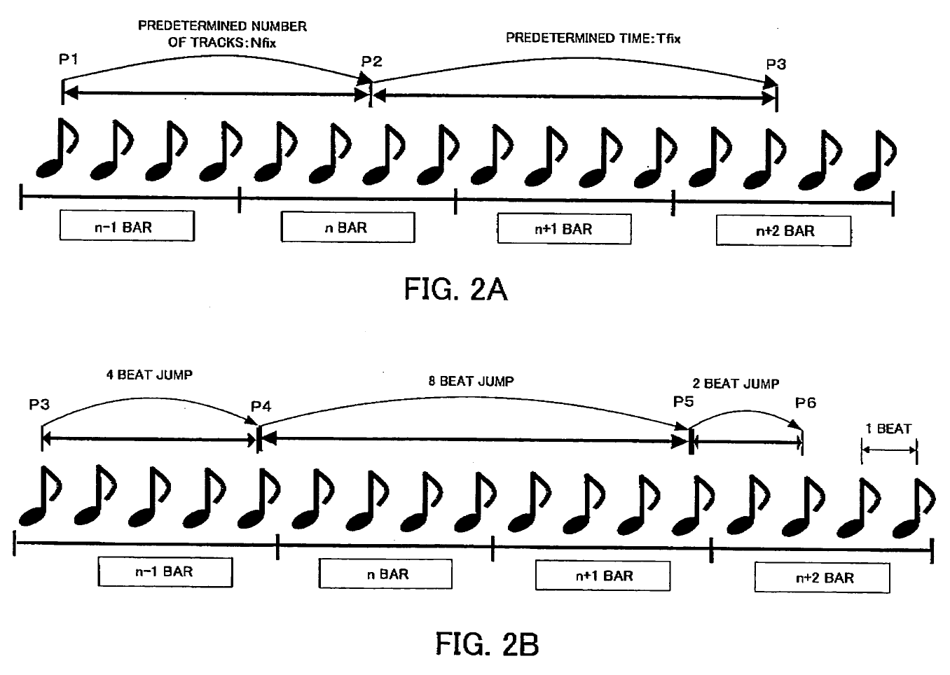

FIG. 2A schematically shows a relation between the reproduction position and the beat position in a case of jumping of the reproduction position by prescribing the movement amount as the predetermined track number Nfix and the predetermined time Tfix. In FIG. 2A, it is defined that each eighth note (quaver) corresponds to one beat. If the jump instruction is inputted at a reproduction position P1 and the reproduction position jumps forward by the fixed track number Nfix, the reproduction start position after the jump becomes a reproduction position P2. However, since the reproduction position P2 is positioned between the eighth notes, the relation of the reproduction position with respect to the beat position changes before and after the jump, and the rhythm of the music becomes discontinuous. Similarly, if the jump instruction is inputted at the reproduction position P2 and the reproduction position jumps forward by the fixed time Tfix, the reproduction start position after the jump becomes the reproduction position P3. The reproduction position P3 is also positioned between the eighth notes, and the relations with the positions (i.e., beat positions) of the preceding and following eighth notes are different from the relations of the reproduction position P2. Hence, the relation of the reproduction position with respect to the beat position problematically changes before and after the jump, and the rhythm of the sound becomes discontinuous.

FIG. 2B schematically shows the relation between the reproduction position and the beat position in such a case that the movement amount corresponding to the jump instruction is prescribed as an integral multiple (i.e., four beats, eight beats and two beats) of one beat. By prescribing the movement amount as the integral multiple of one beat, the reproduction positions P3 to P6 before and after the jump always coincide with the beat positions (eighth note positions). Namely, the relation of the reproduction position with respect to the beat position is maintained before and after the jump, and the rhythm does not become discontinuous. In this embodiment, in the case of jumping of the reproduction position, by prescribing the movement amount as the integral multiple (i.e., the amount of n beats) of one beat of the music during the reproduction, it can be prevented that the rhythm becomes discontinuous before and after the jump.

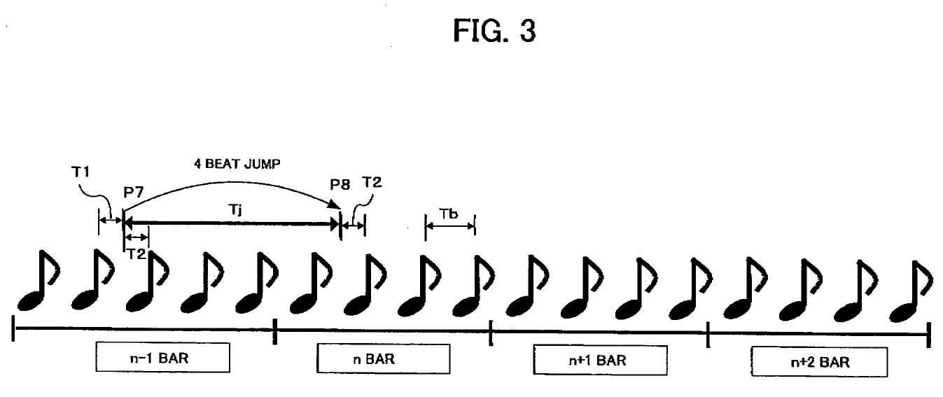

FIG. 2B shows such an example that the reproduction position at the time of starting the jump coincides with the beat position, in order to easily understand the configuration. Namely, the reproduction positions P3 to P6 before and after the jump are always positioned at the positions of the eighth notes. However, it is unnecessary that the reproduction position at the time of starting the jump coincides with the beat position. FIG. 3 shows such an example that the reproduction position at the time of starting the jump does not coincide with the beat position. In FIG. 3, it is assumed that the jump instruction of the amount of four beats is inputted at a reproduction position P7. The reproduction position P7 does not coincide with the beat position (the position of the eighth note). In this case, the reproduction position after the jump becomes P8, and the reproduction position P8 does not coincide with the beat position (the position of the eighth note), either. However, since the movement amount Tj by the jump is the amount of four beats, the positional relation between the reproduction positions P7 and P8 before and after the jump and the beat positions does not change. In FIG. 3, the time from the reproduction position P7 before the jump to the next beat position (the position of the quaver) is T2, and the time from the reproduction position P8 after the jump to the next beat position is also T2. Namely, as shown in FIG. 3, when the time of one beat is prescribed as Tb, such a relation that T1+T2=Tb is formed. Thus, since the relation between the reproduction position and the preceding and following beat positions does not change before and after the jump, the rhythm of the music never becomes discontinuous.

Next, a description will be given of a calculation method of the movement amount in correspondence with the jump instruction. As described above, this embodiment is characterized in that the movement amount is set to the integral multiple (i.e., “n”) of one beat.

If it is defined that the time of one beat is Tb, the movement amount Tj by the jump of the amount of n beats is expressed by an equation below.

Tj=n·Tb (Equation 1)

Thus, if the time Tb of one beat is determined, the movement amount Tj can be calculated.

Normally, the number of beats per unit time is substantially constant in a piece of music. Therefore, in this embodiment, BPM (Beat Per Minute: the number of beats for a minute) is calculated as the number of beats per unit time, based on the data of the music. If it is defined that the calculated BPM is “X”, the time Tb of one beat is expressed by an equation below.

Tb=60/X[second] (Equation 2)

Thus, by obtaining the BPM of the music, the movement amount Tj can be calculated.

The BPM is repeatedly detected during the normal reproduction. Therefore, if there is enough time to scan the entire music in advance of the actual reproduction, it is preferable to calculate the average value of the plural BPMs obtained based on the audio signal of the entire music and thereby calculate the movement amount with using the average value. Though the BPM of a certain piece of music is basically constant through the entire music, the BPMs of some pieces of music are subtly changed. Hence, as described above, the movement amount can be accurately calculated with using the average value of the BPMs obtained through the entire music.

### [Inside Configuration of CD Player]

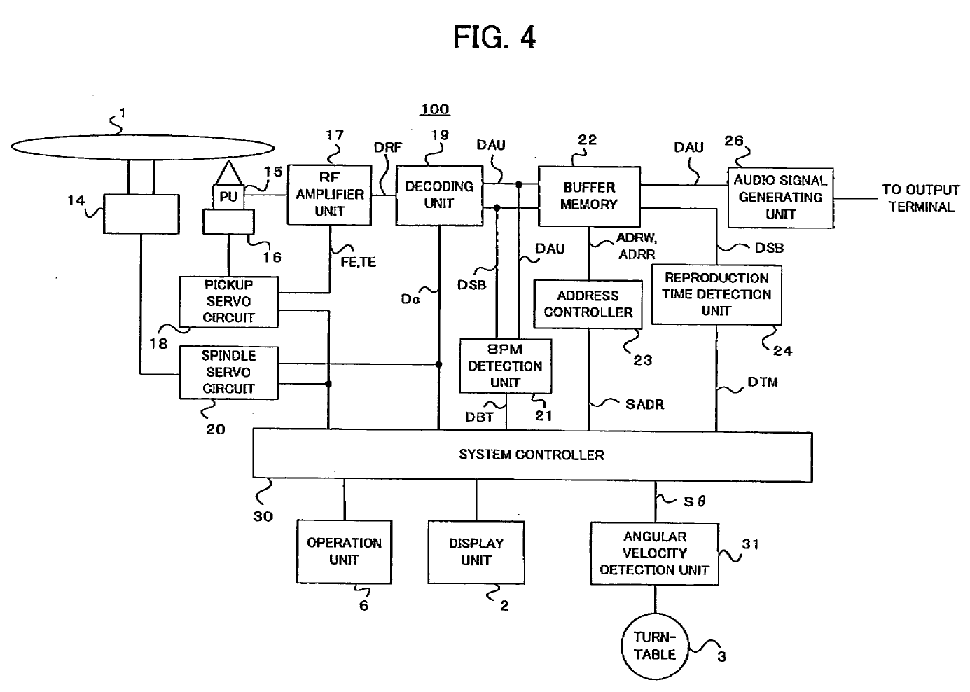

FIG. 4 shows an inside configuration of the CD player 100. In FIG. 4, the CD player 100 includes a spindle motor 14 for rotating an optical disc 1 in a predetermined direction, and a pickup 15 for optically reading the data recorded on the optical disc 1 and outputting the obtained reading signal. In addition, the CD player 100 includes a servo mechanism 16 for moving the pickup 15 to-and-fro in the radius direction of the optical disc 1 and executing servo control to appropriately perform optical reading.

Moreover, the CD player 100 includes an RF amplifier unit 17 and a pickup servo circuit 18. The RF amplifier unit 17 generates an error signal such as a focus error signal FE and a tracking error signal TE from the reading signal outputted from the pickup 15. The pickup servo circuit 18 executes the feedback control of the servo mechanism 16 based on the focus error signal FE and the tracking error signal TE in order to control occurrence of an error such as a focus error and a tracking error.

The pickup servo circuit 18 controls the operation of the servo mechanism 16 in order to move the pickup 15 to a recording track on the optical disc 1 instructed by the system controller 30.

The RF amplifier unit 17 generates, from the reading signal outputted from the pickup 15, the data recorded on the optical disc 1 as an RE signal DRF, and supplies it to a decoding unit 19.

The decoding unit 19 decodes the RF signal DRF in conformity with a format standardized for each optical disc 1, and separates and extracts audio stream DAU and control data Dc included in the RF signal DRF. Then, the decoding unit 19 decodes the audio stream DAU, and supplies it to a BPM detection unit 21 and a buffer memory 22. At the same time, the decoding unit 19 supplies the control data Dc to the system controller 30.

In this stage, various kinds of control data recorded with the audio stream DAU, such as synchronized data and subcode data, are separated and extracted as the control data Dc. The subcode data DSB is synchronized with the audio stream DAU to be supplied to the BPM detection unit 21 and the buffer memory 22 from the decoding unit 19.

The synchronized data is supplied to the spindle servo circuit 20 from the decoding unit 19. Thereby, the spindle servo circuit 20 detects the synchronized data error corresponding to the rotation speed of the spindle motor 14 instructed by the system controller 30, and executes the feedback control of the rotation of the spindle motor 14 in order to suppress occurrence of the error.

The BPM detection unit 21 measures the BPM based on the audio stream DAU supplied from the decoding unit 19. The BPM detection unit 21 includes: a frequency band filter which divides the audio stream DAU into three frequency bands, i.e., a low frequency band, an intermediate frequency band and a high frequency band; a level detection unit which detects the level of the audio data for each frequency band; and a peak detection unit which detects the peak level of the audio data for each frequency band based on the level detection signal outputted from the level detection unit. Then, the BPM detection unit 21 obtains the interval of the peaks timely continuous, based on the peak level of the audio data for each detected frequency band. If it is assumed that the detected peak level corresponds to the beat position of the music, the BPM can be calculated based on the peak interval. Actually, the detection of the peak interval is executed during a predetermined time period, and a statistic process of the detected peak interval value is executed. Thereby, the BPM is calculated.

The above BPM detection method is only one example, and various kinds of BPM detection methods can be used in the present invention. For example, instead of or in addition to the above automatic detection method, by detecting a timing at which the operator pushes a tap button provided on an operation panel of the CD player 100, the BPM may be detected. A detailed example of the BPM detection method is disclosed in Japanese Patent Application Laid-open under No. 8-201542, for example.

The buffer memory 22 is a ring memory formed by SRAM of large capacity (e.g., 64 Mbyte). In the writing address ADRW set by the address controller 23, the buffer memory 22 stores the audio stream DAU and the subcode data DSB which are synchronized with each other and supplied, as a pair of package data, in order.

The system controller 30 detects a passing track time from the subcode data DSB included in the control data Dc, and supplies the address control signal SADR to the address controller 23 for each change of the passing track time. Thereby, the address controller 23 sets the above writing address ADRW.

The buffer memory 22 stores the above package data formed by the audio stream DAU and the subcode data DSB. Afterward, when the reading address ADRR is set by the address controller 23, the buffer memory 22 reads the stored package data from the set reading address ADRR, and divides the data into the original audio stream DAU and the subcode data DSB to output them. Then, the buffer memory 22 supplies the audio stream DAU to the audio signal generating unit 26, and supplies the subcode data DSB to a reproduction time detection unit 24.

The system controller 30 determines the reading address ADRR to be set, based on the reproduction time data DTM outputted from the reproduction time detection unit 24, and supplies the address control signal SADR to the address controller 23. Accordingly, the address controller 23 sets the reading address ADRR.

The reproduction time detection unit 24 examines the contents of the subcode data DSB supplied from the buffer memory 22, and the audio signal generating unit 26 detects the passing track time corresponding to the audio stream DAU during the process. Then, the reproduction time detection unit 24 supplies the detected result to the system controller 30 as the reproduction time data DTM.

Therefore, as described above, the system controller 30 obtains the present passing track time from the reproduction time data DTM, and gives the instruction to the address controller 23 by the address control signal SADR. Thereby, the address controller 23 sets the reading address ADRR of the pack data to be read from the buffer memory 22 so that the discontinuous reproduction sound never occurs.

The audio signal generating unit 26 decodes the audio stream DAU supplied from the buffer memory 22, and directly outputs the digital audio data generated by the decoding to a digital output terminal. Or, the audio signal generating unit 26 converts the audio data into the stereo audio signal of the audio frequency band with using a D/A converter (not shown), and outputs it to an analog output terminal. By connecting the speaker to the analog output terminal, the sound data recorded on the optical disc can be reproduced as the sound.

The system controller 30 includes a microprocessor (MPU). The system controller 30 executes the preset system program, and intensively controls the operation of the entire CD player 100.

The display unit 2 and the operation unit 6 are connected to the system controller 30, and an angular velocity detection unit 31 for detecting the rotation direction and the rotation speed (angular velocity) of the turntable 3 is further connected to the system controller 30.

The angular velocity detection unit 31 optically detects the rotation direction and the rotation speed of the turntable 3 by a rotary encoder circuit (not shown), and supplies the detected data Sθ to the system controller 30. Thereby, the system controller 30 recognizes the operation amount (rotation direction and angular velocity) of the turntable 3 operated by the user. Then, the system controller 30 gives the instruction to the address controller 23 by the address control signal SADR. Thereby, the system controller 30 makes the address controller 23 set the reading address ADRR corresponding to the operation amount of the turntable 3.

Namely, when examining the detected data Sθ and determining that the turntable 3 is not rotated, the system controller 30 instructs the reading address ADRR to be set, based on the reproduction time data DTM supplied from the reproduction time detection unit 24. In addition, when determining that the turntable 3 is rotated, the system controller 30 instructs the reading address ADRR to be set in accordance with the rotation amount of the turntable 3 obtained from the detected data Sθ.

### [Reproduction Process]

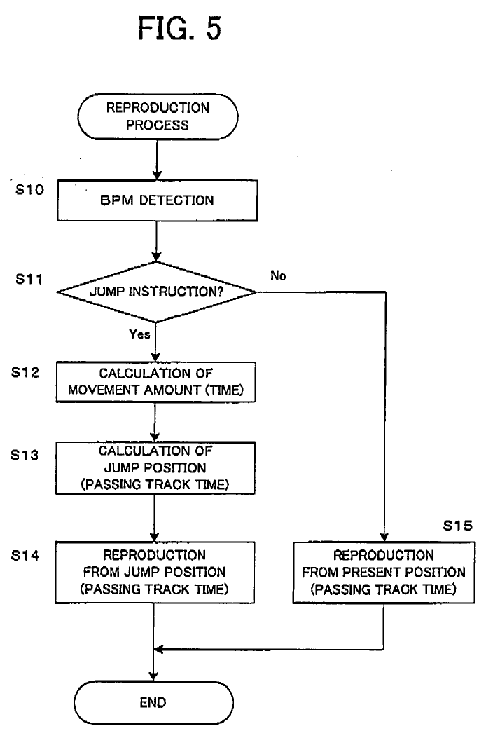

Next, a reproduction process will be explained with reference to FIG. 4 and FIG. 5. FIG. 5 is a flow chart of the reproduction process including the jump process of the reproduction position. The reproduction process which will be explained below is realized by executing the control of each component such as an address controller 23 by the system controller 30 shown in FIG. 4. In the reproduction process, the audio data recorded on the disc 1 is stored in the buffer memory 22, and is read to be reproduced as shown in FIG. 4. The reproduction position on the disc 1 is defined by the passing track time of the audio data stored in the buffer memory 22 and the address of the buffer memory 22.

First, the BPM detection unit 21 detects the BPM during the reproduction of the disc 1 (step S10). The value of the detected BPM is always stored in a memory (not shown) in the system controller 30.

Next, the system controller 30 determines whether or not the jump instruction is inputted by the operator (step S11). The jump instruction is inputted by operating the operation unit 6, shown in FIG. 1, of the operator. Concretely, the operator sets the jump beat number button 6c to the desired jump beat number, and pushes down the forward jump button 6a or the backward jump button 6b. Thereby, the jump instruction is inputted. By detecting the signal showing the execution of the operation of the button in the operation unit 6, the system controller 30 recognizes the input of the jump instruction.

When the jump instruction is inputted (step S11; Yes), the system controller 30 calculates the movement amount (step S12). Concretely, with using the BPM value “X” detected by the RPM detection unit 21, the system controller 30 calculates the time Tb of one beat in accordance with the above-mentioned equation 2. Then, with using the jump beat number “n” instructed by the jump beat button 6c and the time Tb of one beat, the system controller 30 calculates the movement amount (time) Tj in accordance with the above-mentioned equation 1.

Next, the system controller 30 calculates the jump position (step S13). As described above, the system controller 30 obtains the present passing track time from the reproduction time data DTM outputted from the reproduction time detection unit 24. Thus, the passing track time after the jump is calculated by adding the movement amount (time) to the present passing track time, and instructs the correspondent address to the address controller 23 by the address control signal SADR.

The buffer memory 22 supplies the audio stream DAU to the audio signal generating unit 26 from the jump passing track time, and reproduces the audio signal (step S14). In this manner, the jump process is executed. At this time, since the movement amount is set to the integral multiple of the one beat time Tb of the music during the reproduction as described above, the rhythm of the music reproduced before and after the jump never becomes discontinuous.

On the other hand, when it is determined that no jump instruction is inputted in step S11, the system controller 30 supplies the present passing track time to the address controller 23, and the buffer memory 22 supplies the audio signal to the audio signal generating unit 26 from the address corresponding to the present passing track time. As a result, the reproduction of the audio signal is continued from the present passing track time without moving of the reproduction position (step S15).

In the above embodiment, the present invention is applied to the CD player. However, the present invention is also applicable to a recording medium, such as a DVD other than a CD, and a reproduction apparatus such as a memory.

### INDUSTRIAL APPLICABILITY

This invention is usable to the reproduction apparatus for reproducing of the audio signal stored on the recording medium such as a CD and a DVD and in a memory.

1-4. (canceled)

5. An audio signal reproduction apparatus, comprising:
an input unit which receives a movement instruction of a reproduction position of an input audio signal by a unit of a beat of the audio signal;
a movement amount calculation unit which calculates a movement amount of the reproduction position by the unit of the beat of the audio signal based on the movement instruction; and
a reproduction position movement unit which moves the reproduction position with respect to a present reproduction position by the movement amount,
wherein the movement instruction includes a number of movement beats for moving the reproduction position, and
wherein the movement amount calculation unit prescribes a product of a time of one beat of the input audio signal and the number of movement beats as the movement amount.

6. The audio signal reproduction apparatus according to claim 5, further comprising:
a detection unit which detects a number of beats per unit time of the input audio signal; and
a unit which calculates a time of one beat of the input audio signal based on the number of beats per unit time,
wherein the movement amount calculation unit sets the movement amount to an integral multiple of the time of the one beat of the input audio signal.

7. The audio signal reproduction apparatus according to claim 5,
wherein the movement instruction includes a movement direction of moving of the reproduction position, and
wherein the reproduction position movement unit moves the reproduction position in the movement direction.
